(19) United States
(12) Patent Application Publication
(10) Pub. No.: US 2004/0154172 A1
(43) Pub. Date: Aug. 12, 2004

(54) Multiple function pencil sharpening device with integrated eraser element

(76) Inventor: Eliezer Tatz, North Miami Beach, FL (US)

Correspondence Address: Jeffrey H. Kamenetsky, Christopher & Weisberg, P.A., Suite 2040, 200 East Las Olas Boulevard, Fort Lauderdale, FL, 33301, US

(21) Appl. No.: 10/361,970

(22) Filed: Feb. 10, 2003

(51) Int. Cl. B43L 23/00

(52) U.S. Cl. 30/457

(57) ABSTRACT

This invention relates generally to a device that integrates a pencil point protector, a pencil sharpener and a pencil eraser and more specifically to a device adapted at one end to receive the point of a pencil for sharpening the pencil point or protecting the pencil point when the pencil is not in use, and further comprising at its opposite end an eraser element. In the preferred embodiment, the invention is an integrated device for sharpening and protecting a pencil point, and includes an erasing element for erasing pencil marks. The apparatus comprises a body member having a first end and a second end, wherein the first end is sized to receive the pencil point, and the body member is adapted to enclose and secure the pencil point thereby protecting the pencil point from unwanted use and/or breakage. The device further includes a cutting element disposed on the body member for cutting the pencil point when the pencil point is secured within the body member. Cutting occurs upon the rotation of either the cutting element or upon rotation of the pencil along a central axis. Finally, an eraser element is disposed upon the second end of the body member. The body member may include an expandable inner flange and an outwardly-biased expandable outer flap to further assist in gripping and securing the pencil within the device. A clip can be attached to the body member in one embodiment to allow the device to be affixed to clothing or objects.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

This invention relates generally to a device that integrates a pencil point protector, a pencil sharpener and a pencil eraser and more specifically to a device adapted at one end to receive the point of a writing implement, such as a pencil, for sharpening the point and/or protecting the point when the pencil is not in use and further comprising at its opposite end an eraser portion.

### BACKGROUND OF THE INVENTION

Pencil sharpening devices are common in the art. Although electric or battery-operated pencil sharpeners are now common, the original sharpening device was a small portable device that received the writing end of a pencil, and, upon the rotation of the pencil or the sharpener, shaved the point of the pencil radially, by a rectangular blade affixed within the sharpening device. After sharpening the point of the pencil, the pencil sharpener of the prior art is usually stored separately from the pencil. A common problem that occurs is that after the pencil is sharpened, it is often stored in the student's book bag where its sharp point is chipped or broken again prior to the next use, thereby requiring use of the sharpener again before the student uses the pencil. What would be desirable is a way of protecting the point of the pencil after sharpening and during storage to protect the sharpened point.

Pencil erasers come in generally two types; one kind of eraser is a piece of rubber-like material that comes in various sizes and shapes and is separate from the pencil. The other is adapted to fit on the non-writing end of the pencil, thereby remaining attached to the pencil at all times. However, the prior art pencil sharpeners and erasers are separate items and require separate storage. Further, the prior art portable sharpeners only serve to sharpen the point of the pencil but do not provide any protection to the pencil point after the sharpener has been used. Given the widespread usage of standard cap-on erasers, such as the ARROWHEAD® erasers, it is desirable to provide a portable device that incorporates standard components such as the commonly-used cap-on eraser and pencil sharpener, while providing a compartment to house a standard pencil, thereby protecting its point during transport.

Accordingly, what is needed in the art is an integrated device that provides a sharpening tool to sharpen the point of a pencil while also functioning to protect the point of the pencil during storage or transport, and includes an eraser, thereby providing an integrated multipurpose tool that combines the sharpening, erasing and point-protection features of several separate prior art items.

It is, therefore, to the effective resolution of the aforementioned problems and shortcomings of the prior art that the present invention is directed.

### SUMMARY OF THE INVENTION

The present invention advantageously provides a system for protecting a point of a writing implement, the apparatus comprising a body member having a first end and a second end, the first end adapted to receive the point of the writing implement thereby protecting the writing implement point from unwanted use and/or breakage.

In the preferred embodiment, the invention is an integrated device for sharpening and protecting a pencil point, and includes an erasing element for erasing pencil marks. The apparatus comprises a body member having a first end and a second end, wherein the first end is sized to receive a pencil point, and the body member is adapted to enclose and secure the pencil point thereby protecting the pencil point from unwanted use and/or breakage. The device further includes a sharpening element disposed on the body member for sharpening the pencil point when the pencil point is secured within the body member. Sharpening occurs upon the rotation of either the cutting element or upon rotation of the pencil along a central axis. Finally, an eraser element is disposed upon the second end of the body member.

Preferably, the eraser element is removably affixed to the second end of the body member, although the eraser element could also be permanently affixed to the second end of the body member.

Preferably, the body member further comprises a tapered section to conform to the tapered point of a standard pencil thereby maintaining the pencil point in close proximity to the cutting element and to assist in securing the pencil within the base element.

In one embodiment, the apparatus further comprises securing means adapted to receive and secure different diameters of pencils. Preferably, the securing means comprises a conically shaped flexible member disposed along the interior of the body member wherein the flexible member is expandable to receive and secure writing implements of varying diameters. The eraser element can be virtually any type of eraser including the standard cap-on eraser commonly seen on the ends of wooden, number two pencils.

In yet another embodiment, an expanding flap disposed proximate the open end of the body member expands upon the insertion of the pencil. As the point of the pencil is pushed further into the recess of the body member, the expanding flap expands outward to accommodate the larger diameter of the body of the pencil.

In a further embodiment, the apparatus further comprises means for attaching the apparatus to an object, such as, for example, a notebook, folder, notepad, legal pad or binder, or a piece of clothing. The attaching means is an elongated flange protruding from the body member, wherein the flange is adapted to clip onto objects of clothing to secure the apparatus thereto.

The invention can also act as a device that allows a user to easily grip a small writing implement, such as a pencil stub, comprising a substantially arcuate receptacle for receiving the non-writing end of the writing implement, thereby lengthening the writing implement, and means for securing the writing implement within the receptacle. The securing means is comprised of a conically-shaped flexible member described above which is disposed along the interior periphery of the body member, wherein the flexible member is outwardly biased to receive and secure pencils of varying diameters.

It is therefore an object of the present invention to provide an apparatus that combines the separate features of a pencil sharpener, pencil eraser, and a pencil point protector in one integrated device.

It is another object of the present invention to provide a device that can receive and secure virtually any sized writing implement.

It is still another object of the present invention to provide means to secure the device to an object such as a notepad, legal pad, folder, or binder, or to one's clothing thereby allowing the device to be portable.

It is a further object of the present invention to provide an apparatus that combines the separate features of a pencil sharpener, pencil eraser, and a pencil point protector in one integrated device and is adapted to receive a standard number 2 wooden pencil at one end and a standard cap-on ARROWHEAD® eraser at its other end.

It is to be understood that both the foregoing general description and the following detailed description are explanatory and are not restrictive of the invention as claimed. The accompanying drawings, which are incorporated in and constitute part of the specification, illustrate embodiments of the present invention and together with the general description, serve to explain principles of the present invention.

The invention accordingly comprises the features of construction, combination of elements, and arrangement of parts that will be exemplified in the description set forth hereinafter and the scope of the invention will be indicated in the claims.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an exploded perspective view of the preferred embodiment of the invention;

FIG. 2 is a perspective view of the preferred embodiment of the invention;

FIG. 3 is an exploded perspective view of the preferred embodiment of the present invention, shown from the opposite end;

FIG. 4 is a perspective view of the preferred embodiment 5 of the invention, shown from the opposite end;

FIG. 5 is a side cut away view of the preferred embodiment of the present invention;

FIG. 6 is a top down cut away view of the preferred embodiment of the present invention;

FIG. 7 is a perspective view of an alternate use of the present invention;

FIG. 8 is a perspective view of an alternate embodiment of the present invention; and

FIG. 9 is a perspective view of yet another embodiment of the present invention.

### DETAILED DESCRIPTION OF THE INVENTION

The present invention is a device that combines a pencil sharpener with an eraser in one apparatus while also providing a protective shield around the point of the pencil to prevent the pencil point from breaking during storage and/or transport.

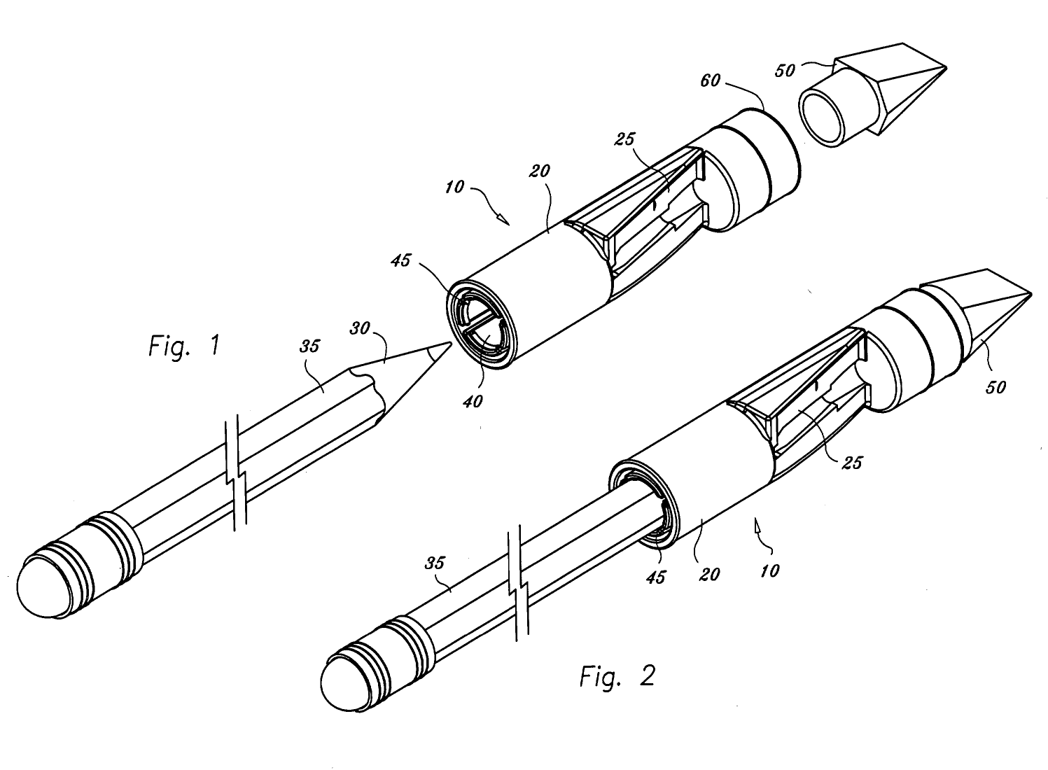

FIG. 1 shows an exploded perspective view of the preferred embodiment of the present invention. Device 10 comprises a main body member 20. Member 20 is preferably comprised of hard plastic and further comprises a cutting element 25 mounted on the upper face of main body member 20. Member 20 could be comprised of other types of sturdy materials including but not limited to, wood, aluminum and other types of metals. Cutting element 25 is preferably rectangular in shape and can be mounted to body member 20 via common fastening means such as one or more screws. Cutting element 25 is preferably a steel blade and, preferably, includes an angled blade edge that protrudes through a slot in body member 20.

Device 10 functions as an integrated tool, combining features of a pencil sharpener, an eraser and a pencil point protector. As shown in FIGS. 1 and 2, the point 30 of a writing implement 35 can be inserted into an open end 40 of body member 20. For illustrative purposes, a pencil will represent writing implement 35. Although a pen, or marker, for example, will not utilize the sharpening features of device 10, it is still desirable to cover the point of the pen during transport to prevent unwanted markings, and to provide an integrated eraser element capable of erasing pen markings. Therefore, the invention is easily adaptable to all writing implements.

Point 30 is inserted within a conically shaped insert 45 within body member 20. Body member 20 could be rectangular, hexagonal, octagonal, cylindrical or, virtually any shape. Insert 45 is comprised of a plurality of arcuate flanges and is positioned around the inner periphery of open end 40 of member 20. The flanges of insert 45 can expand radially outward upon the insertion of point 30 into body member 20. The outwardly expanding capability of insert 45 allows writing implements of different thicknessess to be inserted and secured into the open end 40 of body member 20. Any standard writing implement can be received and secured in this fashion. As pencil point 30 is inserted, the flanges of insert 45 expand outward and abut the inner wall of member 20 as pencil 35 is pushed further into body member 20.

At a certain level, pencil 30 cannot be inserted further due to the inner diameter of body member 20 in relation to the diameter of the inner wall of member 20. As pencil point 30 is inserted into open end 40 of body member 20 and extends therein, conically shaped insert 45 expands until the outer circumference of pencil point 30 abuts the inner walls of body member 20. At this time, insert 45 has expanded to its fullest capacity and point 30 rests just under the angled blade edge of cutting element 25. Insert 45 is shaped to allow pencil point 30 to be secured and positioned directly under blade edge of cutting element 25 so that upon rotation of either pencil 35 and/or device 10 along its central axis, pencil point 30 is cut until the desired point is obtained.

Insert 45 is also shaped in such a manner to allow pencil point 30 to be secured and protected within body member 20 when pencil 35 is not in use. Body member 20 is shaped to conform to the shape of pencil point 30. The interior of body member 20 is tapered at one end to a point approximately the circumference of the tip of pencil point 30. In this fashion, pencil 35 cannot be inserted any further and is secured within body member 20. The point of the writing implement is fully covered and protected to prevent any breakage or unwanted markings.

Referring to FIGS. 1 and 2, body member 20 includes, at the end opposite its open end, an eraser member 50. Eraser member 50 is preferably a standard ARROWHEAD® cap-on eraser, commonly sold in stationary and office supply stores. However, virtually any type of eraser having means to be affixed to one end of device 20 may be used. Preferably, eraser member 50 is removably attached to a second end 60 of body member 20.

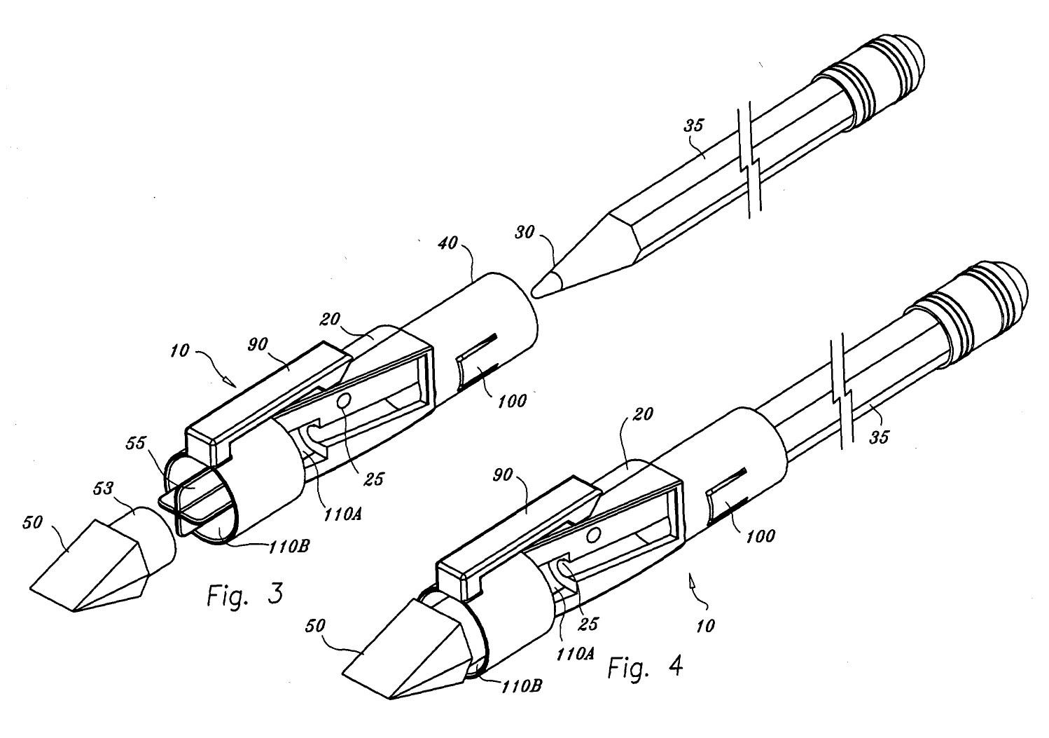

Referring now to FIG. 3, an exploded view of device 10 can be seen, but from an opposite view. Here, device 10 can be seen to include hub 55, upon which eraser element 50 is inserted. Other standard means may be used to attach eraser element 50 to body member 20, including an inner ring that traps the lower part 53 of eraser member 50 between the inner ring and the inner wall of member 20. After the pencil is sharpened, pencil point remnants can escape via slot 110A or from the area 110B surrounding hub 55. In a further embodiment, a capsule-like housing may be fitted over and affixed to member 20, thereby trapping pencil shavings and pencil point remnants therein.

In FIG. 4, it can be seen that the entire device 10 acts as one integrated apparatus that can hold a pencil 35 and protect its point during transport and/or non-use, and includes a cutting element 25 to sharpen the pencil, and an eraser member 50. In one embodiment, clip 90 extends from body member 20 and can be used to fasten device 10 to a piece of clothing, or, preferably, to an object such as a binder, folder, note pad or book. Again, pencil point remnants can exit via slot 110A or area 110B.

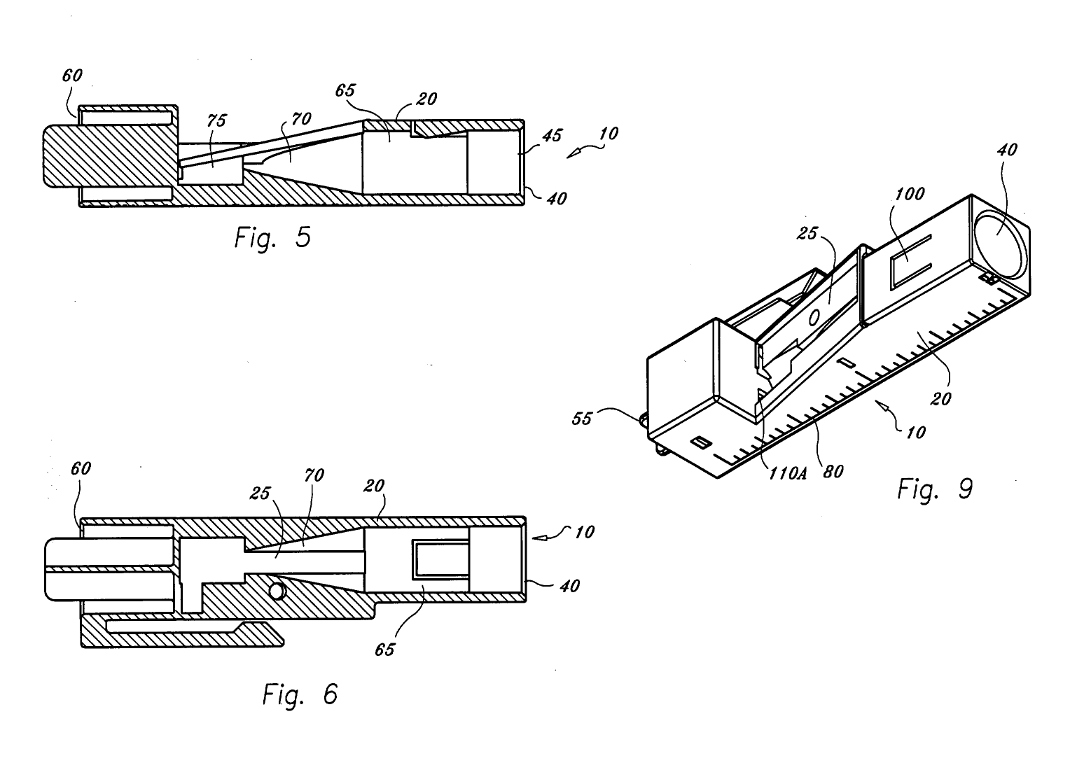

Referring now to FIG. 5, a side cut-away view of the invention can be seen. Open end 40 of body member 20 can be seen to have a fairly large diameter, capable of receiving any standard writing implement. Insert 45, affixed to the inner wall of member 20 proximate open end 40, expands to receive varying pencils diameters, as described above. Second end 60 is adapted to receive eraser element 50. Channel 65 is substantially cylindrical and is adapted to receive a portion of pencil 35 and all of its point 30. Channel 65 gradually narrows to a tapered channel 70, where its width is approximately the width of point 30. Point 30 extends into channel 75, just beneath blade 25, when the pencil 35 is secured within body member 20. Point 30 and a portion of pencil 35 are now secured within channels 65 and 70 of body member 20.

FIG. 6, is a top-down cut-away view of body member 20. Cutting element 25 is positioned, at its one end, above chamber 70. From this illustration it can be seen that a pencil point secured within body member 20 will rest directly underneath the blade of cutting element 25.

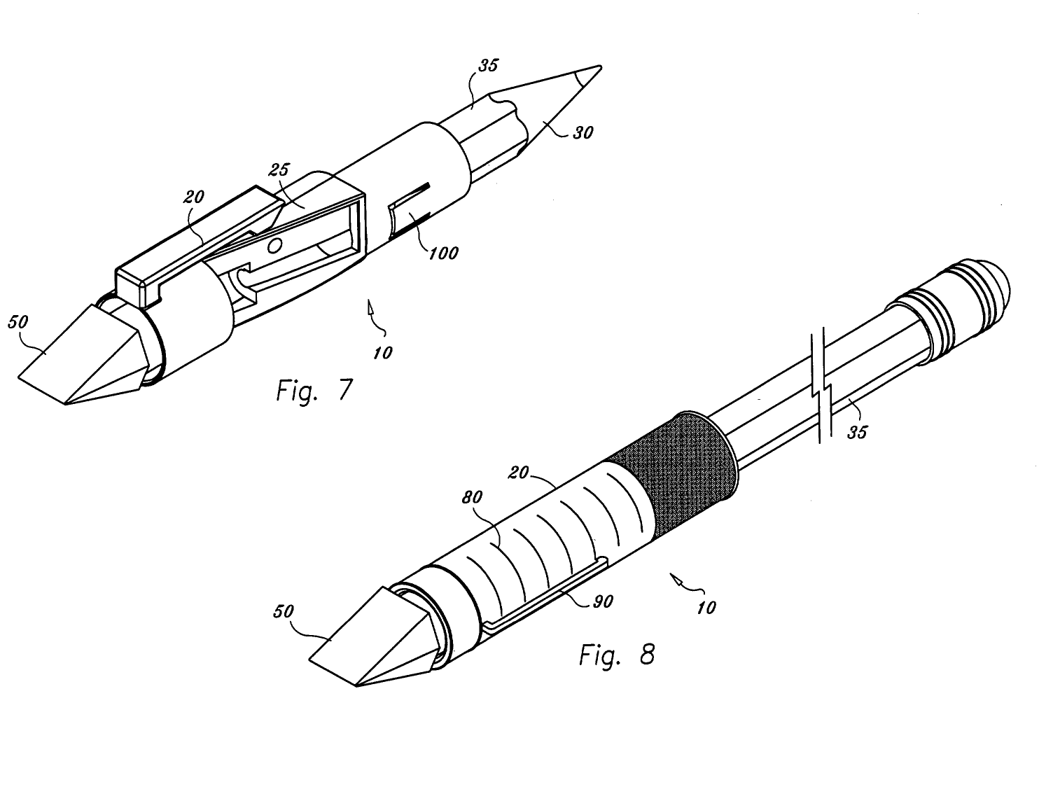

FIG. 7 illustrates another use of the present invention. Device 10 not only acts as a combination pencil point protector, sharpener and eraser, but can also be utilized to assist a user in gripping pencil 35, which has been whittled down to an unusable size. The non-writing end of pencil 35 is inserted into open end 40. Insert 45 receives and grips pencil 35 in the same manner as the pencil was secured when point 30 was first inserted into body member 20, as described above. Body member 20 provides additional length to pencil 35 allowing the user to grasp and use the pencil stub by grasping member 20 into which pencil 35 is secured. Without the use of the device, gripping the pencil stub at the point would be impractical.

Referring to FIG. 7, body member 10 also includes expanding member 100 disposed on its outer surface. Expanding member 100 is a cut-away flap extending from a side of body member 20. Member 100 is adapted to be forced outward when a writing implement is inserted within body member 20. Member 100 allows for pencil bodies with varying larger thickness to be inserted into and secured within device 10. When a writing implement is inserted within open end 40, member 100 may be forced outward to accommodate the body of the writing implement and to provide a secure fit.

FIG. 8 illustrates an alternate embodiment of the invention. Body member 20 includes indicia 80 along its exterior surface. Indicia 80 could be virtually any type of printed material or markings such as advertisements, designs, characters, famous quotations, or ruler markings.

In FIG. 9, yet another embodiment of the present invention is shown. Body member 20 may be rectangular in shape and include indicia 80 in the form of ruler markings. In this particular embodiment, body member 20 is rectangular-shaped in order to accommodate the ruler indicia. Slot 110A is included proximate end 60 of body member 20. Slot 110A provides a means of egress for pencil point remnants after the pencil point has been sharpened.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. An apparatus for protecting a point of a writing implement, the apparatus comprising:
a body member having a first end and a second end, the first end adapted to receive the point of the writing implement thereby protecting the writing implement point from unwanted use and/or breakage; and
an eraser element disposed upon the second end of the body member.

2. The apparatus of claim 1 wherein said eraser element is removably disposed upon the second end of the body member.

3. The apparatus of claim 1 wherein the body member further comprises a tapered section to conform to the point of the writing implement thereby securing the writing implement within the body member.

4. The apparatus of claim 1 further comprising a receiving insert adapted to receive and secure various sized diameters of writing implements.

5. The apparatus of claim 4 wherein the receiving insert comprises an expandable lip disposed around an inner periphery of the first end, wherein the expandable lip is forced outward upon the insertion of the pencil point into the first end thereby allowing the apparatus to receive larger-sized writing implements.

6. The apparatus of claim 1 further comprising a securing flange for removably affixing the apparatus to an object or a piece of clothing.

7. The apparatus of claim 1 wherein the body member is cylindrical.

8. The apparatus of claim 1 wherein the body member is rectangular.

9. The apparatus of claim 1 wherein the body member is hexagonal.

10. The apparatus of claim 1 wherein the body member is octagonal.

11. The apparatus of claim 1 wherein the body member further comprises an expandable flap to accommodate different-sized writing implements.

12. An apparatus for sharpening and protecting a point of a pencil, and erasing pencil marks, the apparatus comprising:
a body member having a first end and a second end, said first end sized to receive the pencil point, the body member adapted to enclose and secure the pencil point thereby protecting the pencil point from unwanted use and/or breakage;
a sharpening element disposed on said body member, the sharpening element for sharpening the pencil point when the pencil point is secured within the body member upon rotation of either the cutting element or the pencil along a central axis; and
an eraser element disposed upon the second end of the body member.

13. The apparatus of 12 wherein said eraser element is removably affixed to the second end of the body member.

14. The apparatus of claim 12 wherein the body member further comprises a tapered section to conform to the point of a pencil thereby maintaining the pencil point in close proximity to the sharpening element and to assist in securing the pencil within the body member.

15. The apparatus of claim 12 further comprising a receiving insert adapted to receive and secure pencil points of varying diameters.

16. The apparatus of claim 15 wherein the receiving insert comprises an expandable lip disposed around an inner periphery of the first end, wherein the expandable lip is forced outward upon the insertion of the pencil point into the first end thereby allowing the apparatus to receive larger-sized writing implements.

17. The apparatus of claim 12 wherein the body member further comprises a groove to allow shaved portions of the pencil point to escape after the pencil point has been sharpened.

18. The apparatus of claim 12 wherein the eraser element is a standard cap eraser.

19. The apparatus of claim 18 wherein the standard cap-on eraser is an ARROWHEAD® eraser.

20. The apparatus of claim 12 further comprising a securing flange for removably affixing the apparatus to an object or a piece of clothing.

21. The apparatus of claim 12 wherein said body member further comprises indicia along its outer surface.

22. The apparatus of claim 21 wherein said indicia are comprised of measurement calibrations.

23. The apparatus of claim 12 wherein the body member is cylindrical.

24. The apparatus of claim 12 wherein the body member is rectangular.

25. The apparatus of claim 12 wherein the body member is hexagonal.

26. The apparatus of claim 12 wherein the body member is octagonal.

27. The apparatus of claim 12 wherein the pencil is a standard number two pencil.

28. The apparatus of claim 12 wherein the body member further comprises an expandable flap to accommodate different-sized writing implements.

29. An apparatus for sharpening and protecting a pencil point, and erasing pencil marks, the apparatus comprising:
a body member having a first end and a second end, said first end sized to receive the pencil point, the body member adapted to enclose and secure the pencil point thereby protecting the pencil point from unwanted use and/or breakage, the body member further comprising an expandable flap to accommodate different-sized writing implements;
an expandable inner receiving flange disposed substantially within an inner periphery of the first end, wherein the receiving flange allows the first end to receive pencil points of varying diameters;
a cutting element disposed on the body member, the cutting element for cutting the pencil point when the pencil point is secured within the body member upon rotation of either the cutting element or the pencil along a central axis, the body member further comprising a tapered section to conform to the point of a pencil thereby maintaining the pencil point in close proximity to the cutting element and to assist in securing the pencil within the base element; and
an eraser removably disposed upon the second end of the body member.

30. A device for allowing a user to grip a small writing implement comprising:
a substantially arcuate receptacle for receiving an end of the writing implement thereby lengthening the writing implement; and
means for securing the writing implement within the receptacle.

31. The device of claim 30 wherein the securing means comprises an expandable lip disposed substantially adjacent an interior periphery of the first end, wherein the expandable lip allows the device to receive and secure writing implements of varying diameter.
